(19) United States
(12) Patent Application Publication
(10) Pub. No.: US 2012/0044210 A1
(43) Pub. Date: Feb. 23, 2012

(54) ELECTRONIC DEVICE WITH SLIDING TOUCH CONTROL FUNCTION AND SLIDING TOUCH CONTROL METHOD THEREOF

(75) Inventors: PING-CHOU CHEN, Tu-Cheng (TW); CHI TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/013,783

(22) Filed: Jan. 25, 2011

(30) Foreign Application Priority Data
Aug. 20, 2010 (CN) 201010258674.3

(51) Int. Cl. G06F 3/042

(52) U.S. Cl. 345/175

(57) ABSTRACT

An electronic device with sliding touch control includes a main body, a main processing unit, and a touch sensing apparatus. The touch sensing apparatus includes a transparent panel mounted on an outer surface of the main body, a circuit board allocated under the transparent panel, a number of photoelectric sensors mounted on the circuit board, and a microprocessor electrically connected to the number of photoelectric sensors. The number of photoelectric sensors generates current signals changing with intensities of light passing through the transparent panel. The microprocessor determines whether the touch sensing apparatus is touched according to received current signals, and transmits the touch information to the main processing unit when a valid touch operation exists. The main processing unit determines a touch track according to the touch information to execute a control command corresponding to the touch track. A sliding touch control method is also provided.

### BACKGROUND

1. Technical Field

The present disclosure relates to electronic devices, and, particularly, to an electronic device with sliding touch control function and a sliding touch control method thereof.

2. Description of Related Art

A mechanical key is often equipped on the housing of an electronic device for adjusting the volume. Electronic devices, such as mobile phones, electronic readers, and media players, which include one or more keys to allow users to conveniently adjust volume, page up and down, or pan the images, are commonly known. Generally, a key secured on the housing of the electronic device includes a keycap, a bracket supporting the keycap, a pivot rotatably connecting the keycap to the bracket, an elastic element, and a switch. In use, the keycap rotates about the pivot when being depressed. The pressure is transmitted to the switch by the elastic element. The switch is actuated and generates an input signal. The elastic element also pushes the keycap back to its normal position. However, the restoring forces of the elastic element become weak or even lost after repeated use, thus the reliability of the key decreases with use.

Therefore, what is needed is an electronic device an a sliding touch control method thereof alleviating the limitations described above.

### BRIEF DESCRIPTION OF THE DRAWINGS

The components in the drawings are not necessarily drawn to scale, the emphasis instead being placed upon clearly illustrating the principles of an electronic device and a sliding touch control method thereof. Moreover, in the drawings, like reference numerals designate corresponding parts throughout the several views.

FIG. 1 is an isometric view of an exemplary embodiment of an electronic device with sliding touch control function.

FIG. 2 is schematic diagram illustrating a touch sensing apparatus of the electronic device of FIG. 1.

FIG. 3 is a block diagram of the electronic device of FIG. 1, according to an exemplary embodiment.

FIG. 4 is a flowchart of a sliding touch control method for electronic devices, such as the one of FIG. 1, in accordance with the exemplary embodiments.

FIG. 5 is a schematic diagram illustrating a sliding touch operation of an electronic device, such as the one of FIG. 1, in accordance with the exemplary embodiment.

### DETAILED DESCRIPTION

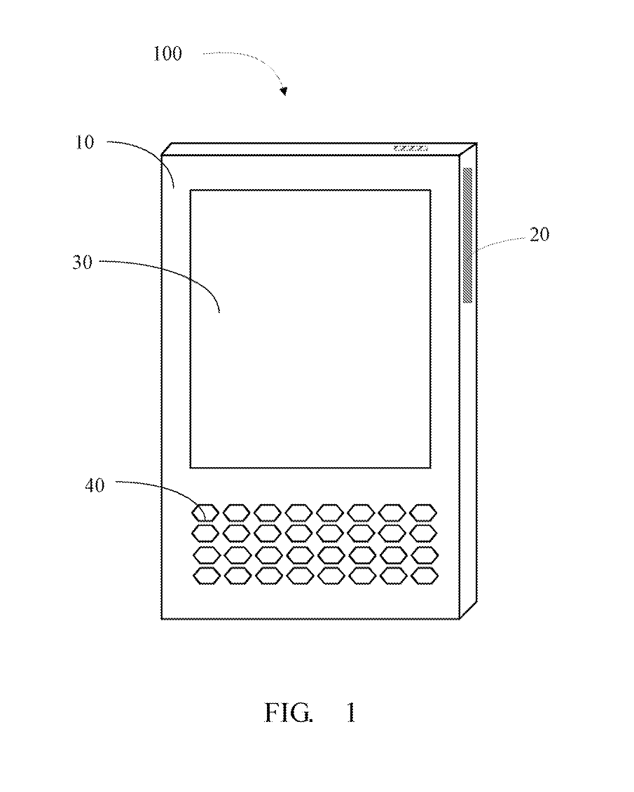

Referring to FIG. 1, an electronic device 100 with sliding touch function is disclosed as an exemplary embodiment. The electronic device 100 includes a main body 10, a touch sensing apparatus 20, a display unit 30, and an input unit 40. The touch sensing apparatus 20 is equipped on the right sidewall of the main body 10. In alternative embodiments, the touch sensing apparatus 20 may be equipped in another suitable place of the main body 10 according to actual need, such as on the left frame, the upper frame, or the lower frame of the main body 10.

The touch sensing apparatus 20 is configured for users to slide a finger thereon to control the electronic device 100. For example, a user may slide a finger on the touch sensing apparatus 20 to adjust a volume of the electronic device 100, or page up and down. In the embodiment, the electronic device 100 is an electronic reader. In another embodiment, the electronic device 100 may be such devices as a mobile phone, a media player, or a digital photo frame.

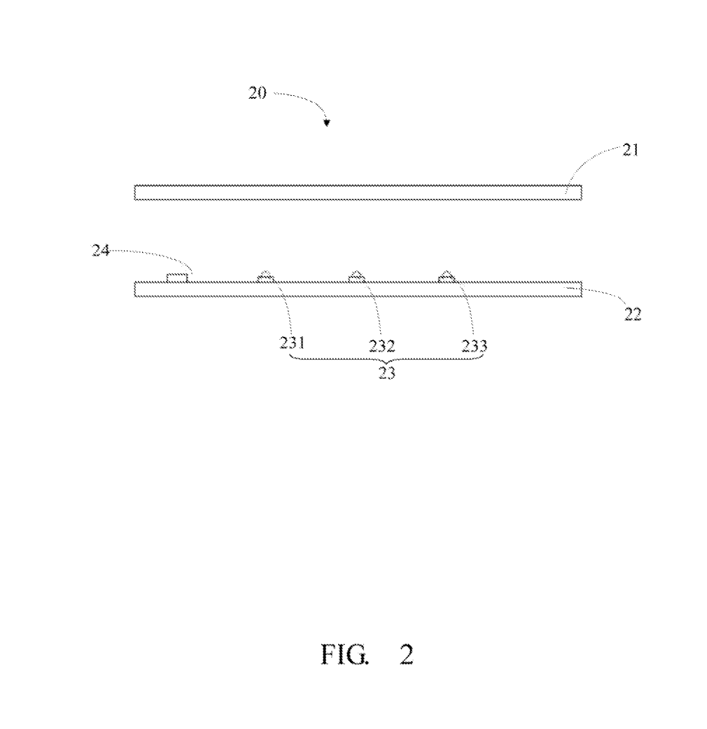

Also referring to FIG. 2, the touch sensing apparatus 20 is received in the main body 10 of the electronic device 100, and includes a transparent panel 21, a circuit board 22, a plurality of photoelectric sensors 23 and a microprocessor 24 mounted on the circuit board 22. The transparent panel 21 is aligned with the upper surface of the main body 10. The circuit board 22 is allocated under the transparent panel 21. The plurality of photoelectric sensors 23 are electrically connected to the microprocessor 24. In the embodiment, there are three photoelectric sensors 23 including a first photoelectric sensor 231, a second photoelectric sensor 232, and a third photoelectric sensor 231. The first, second and third photoelectric sensors 231, 232 and 233 are mounted on the circuit board 22 and aligned in a line. The photoelectric sensors 23 can be the photosensitive diode sensors or the phototransistor sensors, which can generate a plurality of current signals changing with the light intensities. In other words, the photoelectric sensors 23 generates a current signal corresponding to the light intensity, and the larger the light intensity is, the higher the intensity of the current signal is. Otherwise, the smaller the light intensity is, the lower the intensity of the current signal is. When the user touches the touch sensing apparatus 20, the finger shields the transparent panel 21, thus the ambient light beams are mostly blocked by the finger and cannot reach the photoelectric sensors 23. The light intensity detected by the photoelectric sensors 23 is weakened, and the photoelectric sensors 23 generate a lower intensity current signal accordingly.

The microprocessor 24 stores a predetermined threshold value of the intensity of current signals and receives the plurality of current signals generated by the plurality of photoelectric sensors 23. The microprocessor 24 also determines whether the touch sensing apparatus 20 is touched according to the received current signals. Specifically, the microprocessor 24 detects whether the intensities of the received current signals changes, compares the intensities of the received current signals to the predetermined threshold value when the intensities of the received current signals change. When the intensities of the received current signals are lower than the predetermined threshold value, the microprocessor 24 determines there is a valid touch operation applied on the touch sensing apparatus 20. When the intensities of the received current signals remain the same or the intensities of the current signals are higher than the predetermined threshold value, the microprocessor 24 determines there is no touch operation or no valid touch operation applied on the touch sensing apparatus 20. The microprocessor 24 continues to monitor the intensities of the received current signals when the intensities of the received current signals remain the same.

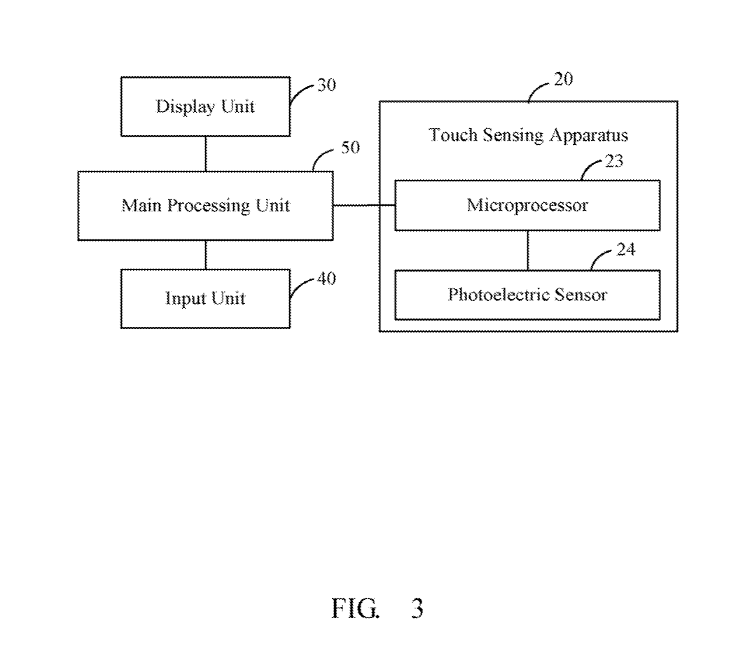

Referring to FIG. 3, the electronic device 100 further includes a main processing unit 50 equipped in the main body 10. The main processing unit 50 is electrically connected to the touch sensing apparatus 20, the display unit 30, and the input unit 40. The microprocessor 24 transmits the touch information of the photoelectric sensors 23 to the main processing unit 50 when a valid touch operation exists.

The main processing unit 50 determines a touch track according to the touch information transmitted from the microprocessor 24. In this embodiment, the main processing unit 50 determines the order of the touch operations on the first, second and third photoelectric sensors 231, 232 and 233 within a predetermined time interval according to the receiving order of the touch information of the first, second and third photoelectric sensors 231, 232 and 233. The predetermined time interval may be set according to actual needs, such as 0.5 seconds, 0.8 seconds, or one second. The main processing unit 50 stores a control command list including a plurality of control commands corresponding to a plurality of touch tracks, and executes the corresponding control commands according to the determined order of the touch operations.

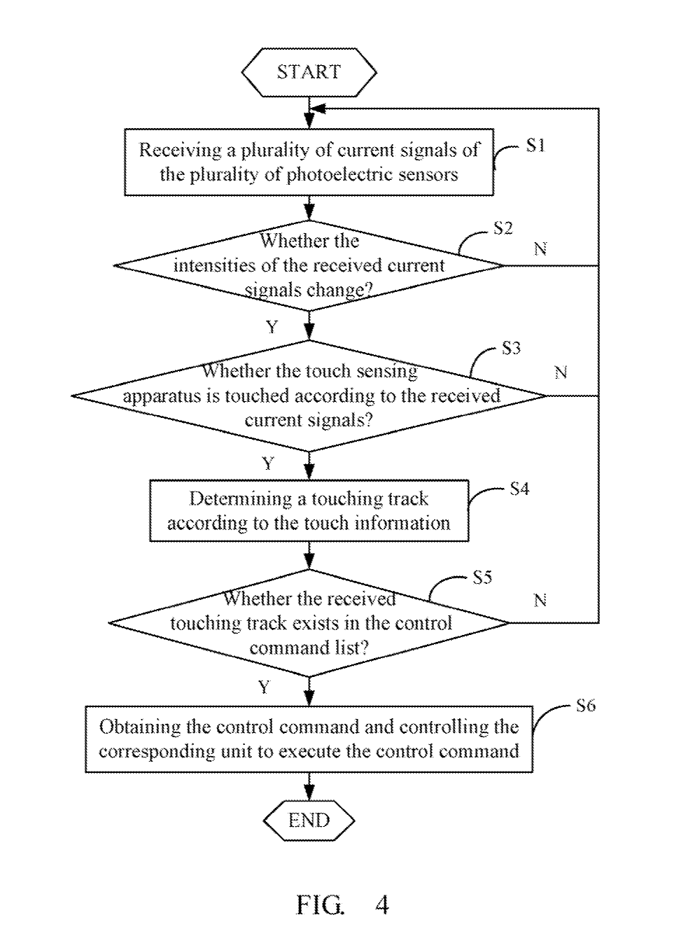

Referring to FIG. 4, a flowchart of a sliding touch control method of the electronic device 100 is shown. The method includes the following steps, each of which is tied to a plurality of components contained in the electronic device 100 as shown in FIG. 3.

In step S1, the microprocessor 24 receives a plurality of current signals of the plurality of photoelectric sensors 23.

In step S2, the microprocessor 24 determines whether the intensities of the received current signals change. If yes, the process goes to step S3, otherwise, the process goes back to step S1.

In step S3, the microprocessor 24 determines whether the touch sensing apparatus 20 is touched according to the received current signals. If yes, the process goes to step S4, otherwise the process goes back to step S1. In this embodiment, the microprocessor 24 compares the intensities of the received current signals with the predetermined threshold value to determine whether the touch sensing apparatus 20 is touched. When the intensities of the received current signals are lower than the predetermined threshold value, the microprocessor 24 determines there is a valid touch operation. When the intensities of the received current signal are higher than the predetermined threshold value, the microprocessor 24 determines there is no valid touch operation, and continues to monitor the intensities of the received current signals.

In step S4, the main processing unit 50 determines a touch track according to the touch information. The main processing unit 50 determines the touch track is from the first photoelectric sensor 231 to the third photoelectric sensor 233 according to the touched order on the first, second and third photoelectric sensors 231, 232 and 233 within a predetermined time interval according to the receiving order of the touch information. The predetermined time interval may be set according to actual needs, such as 0.5 seconds, 0.8 seconds, or one second.

In Step S5, the main processing unit 50 determines whether the received touch track transmitted from the microprocessor 24 exists in the stored control command list. If yes, the process goes to Step S6, otherwise, the process goes back to step S1. In the embodiment, the control command list includes a plurality of control commands corresponding to the plurality of touch tracks.

In Step S6, the main processing unit 50 obtains the control command and controls the corresponding unit to execute the control command.

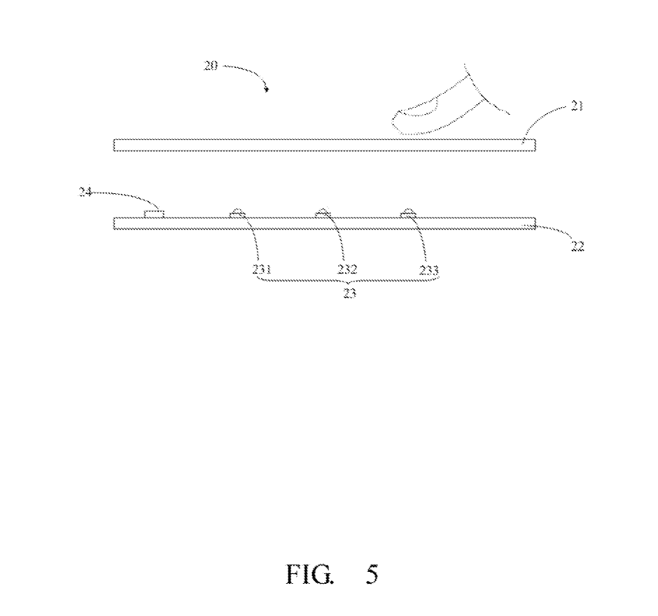

FIG. 5 is a schematic diagram illustrating a sliding touch operation of an electronic device, such as the one of FIG. 1, in accordance with the exemplary embodiment. When a finger slides on the touch sensing apparatus 20, a finger shields the transparent panel 21, thus the light cannot reach the photoelectric sensors 23 directly. The microprocessor 23 determines the intensities of the current signals transmitted from the photoelectric sensor 23 change and become lower than the predetermined threshold value. The microprocessor 23 also transmits the touch information on the photoelectric sensors 23 to the main processing unit 50.

The main processing unit 50 determines the photoelectric sensor 23 is touched according to the touch information. The main processing unit 50 also determines the order of the touch operations on the first, second and third photoelectric sensors 231, 232 and 233 within a predetermined time interval according to the receiving order of the touch information. Thus, the main processing unit 50 determines a touch track and controls a corresponding unit to execute a control command corresponding to the touch track stored therein.

For detail illustration, when a finger slides from the first photoelectric sensor 231 to the third photoelectric sensor 233, the first, second and third photoelectric sensors 231, 232 and 233 are shielded by the finger in sequence. The microprocessor 24 determines the intensities of the current signals generated by the first, second and third photoelectric sensors 231, 232 and 233 are lower than the predetermined threshold value, and transmits the touch information on the first, second and third photoelectric sensors 231, 232 and 233 to the main processing unit 50 in sequence. The main processing unit 50 determines the touch track is from the first photoelectric sensor 231 to the third photoelectric sensor 233 according to the touched order on the first, second and third photoelectric sensors 231, 232 and 233 within the predetermined time period. The main processing unit 50 also controls corresponding unit(s) to execute the control command corresponding to the touch track stored therein. In the embodiment, the control command is to control a display to display a next page. The main processing unit 50 accordingly controls the display unit 30 to display the next page.

When a finger slides from the third photoelectric sensor 233 to the first photoelectric sensor 231, the third, second and first photoelectric sensors 233, 232 and 231 are shielded by the finger in sequence. The microprocessor 24 determines the intensities of the current values generated by the first, second and third photoelectric sensors 231, 232 and 233 are lower than the predetermined threshold current. The microprocessor 24 transmits the touch information on the third, second and first photoelectric sensors 233, 232, and 231 to the main processing unit 50 in sequence. The main processing unit 50 determines the touch track is from the third photoelectric sensor 233 to the first photoelectric sensor 231 according to the touched order on the third, second and first photoelectric sensors 233, 232, and 231 within the predetermined time period. The main processing unit 50 also controls corresponding unit(s) to execute the control command corresponding to the touch track stored therein. The main processing unit 50 accordingly controls the display unit 30 to display the previous page.

A slide on the touch sensing apparatus 20 may page up and down when the electronic device 100 is an electronic reader. A slide on the touch sensing apparatus 20 may switch songs when the electronic device 100 is a media player. A slide on the touch sensing apparatus 20 may flip photos when the electronic device 100 is a digital photo frame.

The touch sensing apparatus 20 operates the electronic device 100 by slide touches, compared to the commonly used mechanical keys, the reliability of the electronic device 100 increases.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device with sliding touch control function, comprising:
a main body;
a main processing unit equipped in the main body; and
a touch sensing apparatus equipped on the main body and comprising:
a transparent panel mounted on an outer surface of the main body;
a circuit board allocated under the transparent panel;
a plurality of photoelectric sensors mounted on the circuit board and configured for generating current signals changing with intensities of light passing through the transparent panel, and
a microprocessor electrically connected to the plurality of photoelectric sensors, configured for determining whether the touch sensing apparatus is touched according to received current signals generated by the plurality of photoelectric sensors, and transmitting the touch information of the plurality of photoelectric sensors to the main processing unit when a valid touch operation is determined;
wherein the main processing unit determines a touch track according to the touch information and controls to execute a control command corresponding to the touch track.

2. The electronic device as described in claim 1, wherein the main processing unit determines the touch track according to the order of the touch operations on the plurality of the photoelectric sensors within a predetermined time interval, wherein the order of the touch operations on the plurality of the photoelectric sensors is determined according to the receiving order of the touch information of the plurality of the photoelectric sensors.

3. The electronic device as described in claim 2, wherein the microprocessor stores a predetermined threshold value for the intensities of the current signals, detects whether the intensities of the received current signals change, and compares the intensities of the received current signals to the predetermined threshold value when the intensities of the received current signals change.

4. The electronic device as described in claim 3, wherein the microprocessor determines that there is a valid touch operation applied on the touch sensing apparatus when the intensities of the received current signals are lower than the predetermined threshold value.

5. The electronic device as described in claim 3, wherein the microprocessor determines there is no touch operation or no valid touch operation applied on the touch sensing apparatus when the intensities of the received current signals remain the same or the intensities of the current signals are higher than the predetermined threshold value.

6. The electronic device as described in claim 3, wherein the microprocessor is to continue to monitor the intensities of the received current signals generated by the plurality of photoelectric sensors when the intensities of the received current signals remain the same.

7. The electronic device as described in claim 1, wherein the main processing unit stores a control command list including a plurality of control commands corresponding to a plurality of touch tracks.

8. The electronic device as described in claim 7, wherein the plurality of control commands comprises paging up and down, switching between songs and flipping photos.

9. The electronic device as described in claim 1, wherein the number of the plurality of the photoelectric sensors is three.

10. An electronic reader with sliding touch control function, comprising:
a main body;
a main processing unit equipped in the main body; and
a touch sensing apparatus equipped on the main body and comprising:
a transparent panel mounted on an outer surface of the main body;
a circuit board allocated under the transparent panel;
a plurality of photoelectric sensors mounted on the circuit board and configured for generating current signals changing with intensities of light passing through the transparent panel, and
a microprocessor electrically connected to the plurality of photoelectric sensors, configured for determining whether the touch sensing apparatus is touched according to received current signals generated by the plurality of photoelectric sensors, and transmitting the touch information of the plurality of photoelectric sensors to the main processing unit when a valid touch operation is determined;
wherein the main processing unit determines a touch track according to the touch information and controls to execute a control command corresponding to the touch track.

11. The electronic reader as described in claim 10, wherein the main processing unit determines the touch track according to the order of the touch operations on the plurality of the photoelectric sensors within a predetermined time interval, wherein the order of the touch operations on the plurality of the photoelectric sensors is determined according to the receiving order of the touch information of the plurality of the photoelectric sensors.

12. The electronic reader as described in claim 11, wherein the microprocessor stores a predetermined threshold value for the intensities of the current signals, detects whether the intensities of the received current signals change, and compares the intensities of the received current signals to the predetermined threshold value when the intensities of the received current signals change.

13. The electronic reader as described in claim 12, wherein the microprocessor determines that there is a valid touch operation applied on the touch sensing apparatus when the intensities of the received current signals are lower than the predetermined threshold value.

14. The electronic reader as described in claim 12, wherein the microprocessor determines there is no touch operation or no valid touch operation applied on the touch sensing apparatus when the intensities of the received current signals remain the same or the intensities of the current signals are higher than the predetermined threshold value.

15. The electronic reader as described in claim 12, wherein the microprocessor is to continue to monitor the intensities of the received current signals generated by the plurality of photoelectric sensors when the intensities of the received current signals remain the same.

16. The electronic reader as described in claim 10, wherein the main processing unit stores a control command list including a plurality of control commands corresponding to a plurality of touch tracks.

17. The electronic reader as described in claim 10, wherein the control commands comprises paging up and down and switching between songs.

18. The electronic reader as described in claim 10, wherein the number of the plurality of the photoelectric sensors is three.

19. A sliding control method for an electronic device, the electronic device comprises a touch sensing apparatus comprising a plurality of photoelectric sensors, the method comprising:
receiving a plurality of current signals of the plurality of photoelectric sensors;
determining whether intensities of current signals change;
determining whether the touch sensing apparatus is touched according to the current signals, when intensities of the current signals change;
determining a touch track when the touch sensing apparatus is touched;
determining whether the touch track exists in a stored control command list;
obtaining control command when the touch track exists; and
executing the control command.

20. The method as described in claim 19, wherein the touch track is determined according to the touched order on the plurality of photoelectric sensors within a predetermined time interval.
